(19) United States
(12) Patent Application Publication
(10) Pub. No.: US 2015/0016517 A1
(43) Pub. Date: Jan. 15, 2015

(54) ENCODING DEVICE AND ENCODING METHOD, AND DECODING DEVICE AND DECODING METHOD

(71) Applicant: SONY CORPORATION, Tokyo (JP)

(72) Inventors: HIRONORI MORI, Tokyo (JP); KATSUHISA ITO, Tokyo (JP); KENGO HAYASAKA, Kanagawa (JP)

(21) Appl. No.: 14/322,532

(22) Filed: Jul. 2, 2014

(30) Foreign Application Priority Data
Jul. 12, 2013 (JP) 2013-146806

(51) Int. Cl. H04N 19/597

(52) U.S. Cl. CPC H04N 19/00769
USPC 375/240.12

(57) ABSTRACT

Provided is an encoding device including a non-occlusion region encoding unit configured to encode a difference between an image of a neighboring viewpoint, which is a viewpoint different from a criterion viewpoint, and a predicted image of the neighboring viewpoint of a non-occlusion region of the image of the neighboring viewpoint according to a first encoding scheme, and an occlusion region encoding unit configured to encode an occlusion region of the image of the neighboring viewpoint according to a second encoding scheme different from the first encoding scheme.

### CROSS REFERENCE TO RELATED APPLICATIONS

This application claims the benefit of Japanese Priority Patent Application JP 2013-146806 filed Jul. 12, 2013, the entire contents of which are incorporated herein by reference.

### BACKGROUND

The present disclosure relates to an encoding device and an encoding method, and a decoding device and a decoding method, and more particularly, to an encoding device and an encoding method capable of performing highly efficient encoding while maintaining image quality of an image of a neighboring viewpoint, and a decoding device and a decoding method.

As a scheme of encoding a multi-viewpoint image which is an image of a plurality of viewpoints, for example, there is a Multiview Video Coding (MVC) scheme of performing encoding by applying motion compensation prediction even between viewpoints as in frames (for example, see “H.264-Advanced video coding for generic audiovisual services,” ITU-T, 2009.3). There is also a 3D video/Free-viewpoint Television (3DV/FTV) scheme of encoding a depth map, which is generated from a multi-viewpoint image of fewer viewpoints than necessary and indicates the position of a subject in a depth direction along with a multi-viewpoint image, and generating an image of necessary viewpoints using the depth map and the multi-viewpoint image at the time of decoding.

In the MVC scheme, motion compensation in a time direction and disparity compensation in a space direction are performed by block matching. In the 3DV/FTV scheme, schemes of encoding a depth image and a multi-viewpoint image are collectively referred to as a Multi-View Depth (MVD) scheme. In the MVD scheme, an Advance Video Coding (AVC) scheme, an MVC scheme, and the like of the related art are used.

An image or a depth map of each viewpoint can be generated by performing projection from an image or a depth map of a criterion viewpoint which is a single viewpoint serving as a criterion outside of an occlusion region (which will be described in detail below). Accordingly, as a scheme of encoding a multi-viewpoint image, there is also a Layered Depth Video (LDV) scheme realizing efficient encoding by encoding a depth map and an image of a criterion viewpoint, and a depth map and an image of an occlusion region of a neighboring viewpoint, which is a viewpoint other than the criterion viewpoint.

The occlusion region refers to a region of a subject which is present in an image of a neighboring viewpoint but is not present in an image of a criterion viewpoint.

### SUMMARY

All of the above-described schemes of encoding a multi-viewpoint image are lossy encoding schemes since the purpose of the schemes is to perform highly efficient encoding. Therefore, image quality may not be maintained.

It is desirable to provide a technology for performing highly efficient encoding while maintaining image quality of an image of a neighboring viewpoint.

An encoding device according to a first embodiment of the present disclosure is an encoding device including a non-occlusion region encoding unit configured to encode a difference between an image of a neighboring viewpoint, which is a viewpoint different from a criterion viewpoint, and a predicted image of the neighboring viewpoint of a non-occlusion region of the image of the neighboring viewpoint according to a first encoding scheme, and an occlusion region encoding unit configured to encode an occlusion region of the image of the neighboring viewpoint according to a second encoding scheme different from the first encoding scheme.

An encoding method according to the first embodiment of the present disclosure corresponds to the encoding device according to the first embodiment of the present disclosure.

According to the first embodiment of the present disclosure, a difference between an image of a neighboring viewpoint, which is a viewpoint different from a criterion viewpoint, and a predicted image of the neighboring viewpoint of a non-occlusion region of the image of the neighboring viewpoint is encoded according to the first encoding scheme. An occlusion region of the image of the neighboring viewpoint is encoded according to a second encoding scheme different from the first encoding scheme.

A decoding device according to a second embodiment of the present disclosure is a decoding device including a non-occlusion region decoding unit configured to decode encoded data, which is obtained by encoding a difference between an image of a neighboring viewpoint, which is a viewpoint different from a criterion viewpoint, and a predicted image of the neighboring viewpoint of a non-occlusion region of the image of the neighboring viewpoint according to a first encoding scheme, according to a first decoding scheme corresponding to the first encoding scheme, and an occlusion region decoding unit configured to decode encoded data, which is obtained by encoding an occlusion region of the image of the neighboring viewpoint according to a second encoding scheme different from the first encoding scheme, according to a second decoding scheme corresponding to the second encoding scheme.

A decoding method according to the second embodiment of the present disclosure corresponds to the decoding device according to the second embodiment of the present disclosure.

According to the second embodiment of the present disclosure, encoded data, which is obtained by encoding a difference between an image of a neighboring viewpoint, which is a viewpoint different from a criterion viewpoint, and a predicted image of the neighboring viewpoint of a non-occlusion region of the image of the neighboring viewpoint according to a first encoding scheme, is decoded according to a first decoding scheme corresponding to the first encoding scheme. Encoded data, which is obtained by encoding an occlusion region of the image of the neighboring viewpoint according to a second encoding scheme different from the first encoding scheme, is decoded according to a second decoding scheme corresponding to the second encoding scheme.

The encoding device according to the first embodiment and the decoding device according to the second embodiment can be realized by causing a computer to execute a program.

To realize the encoding device according to the first embodiment and the decoding device according to the second embodiment, the program caused to be executed by the computer can be transmitted via a transmission medium or can be recorded on a recording medium to be provided.

According to the first embodiment of the present disclosure, it is possible to perform highly efficient encoding while maintaining image quality of the image of the neighboring viewpoint.

According to the second embodiment of the present disclosure, it is possible to decode the encoded data encoded with high efficiency while maintaining the image quality of the image of the neighboring viewpoint.

### BRIEF DESCRIPTION OF THE DRAWINGS

FIG. 1 is a block diagram illustrating an example of the configuration of an image processing system of a first embodiment to which the present disclosure is applied;

FIG. 2 is a diagram for describing the flow of a process of the image processing system in FIG. 1;

FIG. 3 is a block diagram illustrating an example of the configuration of an encoding device in FIG. 1;

FIG. 4 is a diagram for describing generation of a predicted image;

FIG. 5 is a flowchart for describing an encoding process of the encoding device in FIG. 3;

FIG. 6 is a block diagram illustrating an example of the configuration of a decoding device in FIG. 1;

FIG. 7 is a flowchart for describing a decoding process of the decoding device in FIG. 6;

FIG. 8 is a diagram illustrating an example of the configuration of an encoding device of an image processing system of a second embodiment to which the present disclosure is applied;

FIG. 9 is a diagram for describing separation of a difference of a non-occlusion region;

FIG. 10 is a flowchart for describing an encoding process of the encoding device in FIG. 8;

FIG. 11 is a block diagram illustrating an example of the configuration of a decoding device of the image processing system of the second embodiment to which the present disclosure is applied;

FIG. 12 is a flowchart for describing a decoding process of the decoding device in FIG. 11;

FIG. 13 is a diagram illustrating a first example of a relation between uses and encoding schemes;

FIG. 14 is a diagram illustrating a second example of a relation between uses and encoding schemes;

FIG. 15 is a block diagram illustrating an example of a hardware configuration of a computer; and

FIG. 16 is a diagram for describing disparity and depth.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### First Embodiment

### Example of Configuration of Image Processing System of First Embodiment

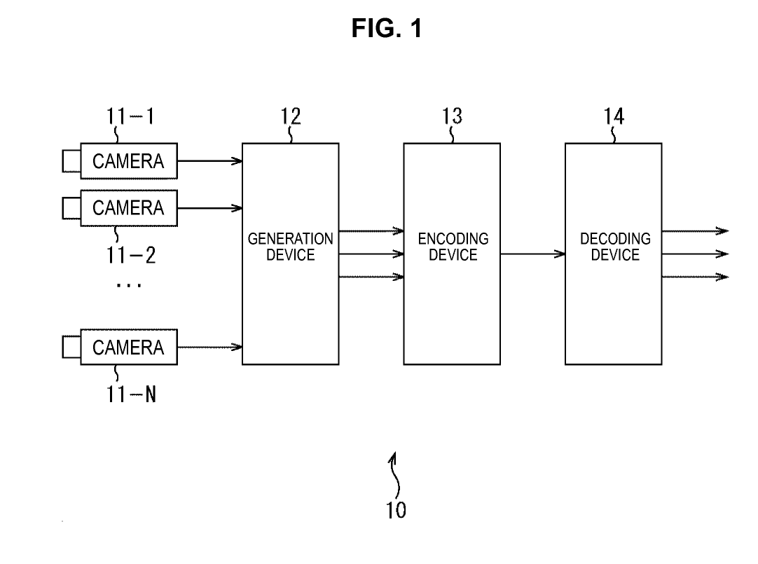

FIG. 1 is a block diagram illustrating an example of the configuration of an image processing system of a first embodiment to which the present disclosure is applied.

An image processing system 10 in FIG. 1 is configured to include N (where N is an integer of 2 or more) cameras 11-1 to 11-N, a generation device 12, an encoding device 13, and a decoding device 14. The image processing system 10 encodes a captured image of N viewpoints and a depth map of a criterion viewpoint and decodes the encoded captured image.

Specifically, the cameras 11-1 to 11-N of the image processing system 10 each image a subject at N mutually different viewpoints. The images of the N viewpoints captured by the cameras 11-1 to 11-N are supplied to the generation device 12. Hereinafter, when it is not particularly necessary to distinguish the cameras 11-1 to 11-N from each other, the cameras 11-1 to 11-N are collectively referred to as the cameras 11.

The generation device 12 generates a depth map of a criterion viewpoint from the images of the N viewpoints supplied from the cameras 11-1 to 11-N by stereo matching or the like. The generation device 12 supplies the encoding device 13 with the image of the criterion viewpoint, the images of the remaining neighboring viewpoints, and the depth map among the images of the N viewpoints.

The encoding device 13 generates a predicted image of a neighboring viewpoint by moving each pixel of the image of the criterion viewpoint supplied from the generation device 12 based on the depth map. There is no pixel value in an occlusion region of the predicted image of the neighboring viewpoint generated in this way.

For a non-occlusion region, the encoding device 13 obtains a difference between the predicted image of the neighboring viewpoint and the image of the neighboring viewpoint supplied from the generation device 12. The encoding device 13 generates encoded data by performing lossless encoding on the difference, such as entropy encoding of higher quality than lossy encoding. On the other hand, for the occlusion region, the encoding device 13 generates encoded data by performing lossy encoding on the image of the neighboring viewpoint supplied from the generation device 12.

The encoding device 13 generates encoded data by performing lossless encoding on the depth map and the image of the criterion viewpoint. The encoding device 13 generates an encoded stream by multiplexing the encoded data of the image of the neighboring viewpoint of the occlusion region, the difference of the non-occlusion region, the image of the criterion viewpoint, and the depth map. The encoding device 13 transmits the encoded stream to the decoding device 14.

The decoding device 14 separates the encoded stream transmitted from the encoding device 13 into the encoded data of the image of the neighboring viewpoint of the occlusion region, the difference of the non-occlusion region, the image of the criterion viewpoint, and the depth map.

The decoding device 14 decodes the encoded data of the image of the neighboring viewpoint of the occlusion region, the difference of the non-occlusion region, the image of the criterion viewpoint, and the depth map according to a decoding scheme corresponding to the encoding scheme of the encoding device 13.

Specifically, the decoding device 14 performs lossless decoding of higher equality than lossy decoding on the encoded data of the difference of the non-occlusion region, the image of the criterion viewpoint, and the depth map and performs lossy decoding on the encoded data of the image of the neighboring viewpoint of the occlusion region. The decoding device 14 generates a residual image by combining the image of the neighboring viewpoint of the occlusion region and the difference of the non-occlusion region obtained as the decoding result.

As in the encoding device 13, the decoding device 14 generates a predicted image of the neighboring viewpoint by moving each pixel of the image of the criterion viewpoint obtained as the decoding result based on the depth map. Then, the decoding device 14 generates an image of the neighboring viewpoint by adding the predicted image of the neighboring viewpoint to the residual image. At this time, since there is no pixel value of the predicted image of the neighboring viewpoint in the occlusion region, the pixel value of the residual image becomes the pixel value of the image of the neighboring viewpoint without change. The decoding device 14 outputs the image of the neighboring viewpoint, and the image of the criterion viewpoint and the depth map obtained as the decoding result.

In the image processing system 10, as described above, the difference of the non-occlusion region is subjected to the lossless encoding. Therefore, the image quality of the difference of the non-occlusion region obtained as the decoding result is improved more than when the difference of the non-occlusion region is subjected to the lossy encoding. Accordingly, the image quality of the image of the neighboring viewpoint of the non-occlusion region generated using the difference is also improved.

(Description of Flow of Process of Image Processing System)

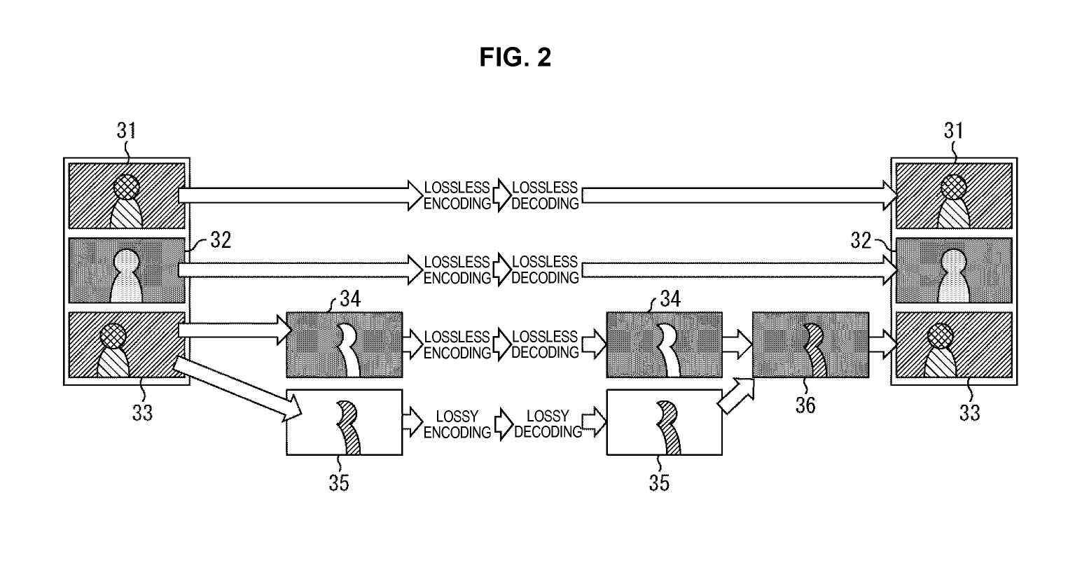

FIG. 2 is a diagram for describing the flow of a process of the image processing system 10 in FIG. 1.

As illustrated in FIG. 2, in the image processing system 10, an image 31 of a criterion viewpoint is subjected to the lossless encoding by the encoding device 13 and is subjected to the lossless decoding to be restored by the decoding device 14. Likewise, a depth map 32 of the criterion viewpoint generated by the generation device 12 is subjected to the lossless encoding by the encoding device 13 and is subjected to the lossless decoding to be restored by the decoding device 14.

On the other hand, for a non-occlusion region of an image 33 of a neighboring viewpoint, a difference 34 between the image 33 and a predicted image generated by moving the image 31 based on the depth map 32 is subjected to the lossless encoding by the encoding device 13 and is subjected to the lossless decoding by the decoding device 14.

For an occlusion region of the image 33 of the neighboring viewpoint, the image 33 is subjected to the lossy encoding as an image 35 by the encoding device 13 without change and is subjected to the lossy decoding to be restored by the decoding device 14.

Then, the difference 34 and the image 35 are combined by the decoding device 14 to generate a residual image 36. The residual image 36 is added to a predicted image generated by the decoding device 14 by moving each pixel of the image 31 based on the depth map 32. In this way, the image 33 is restored.

(Example of Configuration of Encoding Device)

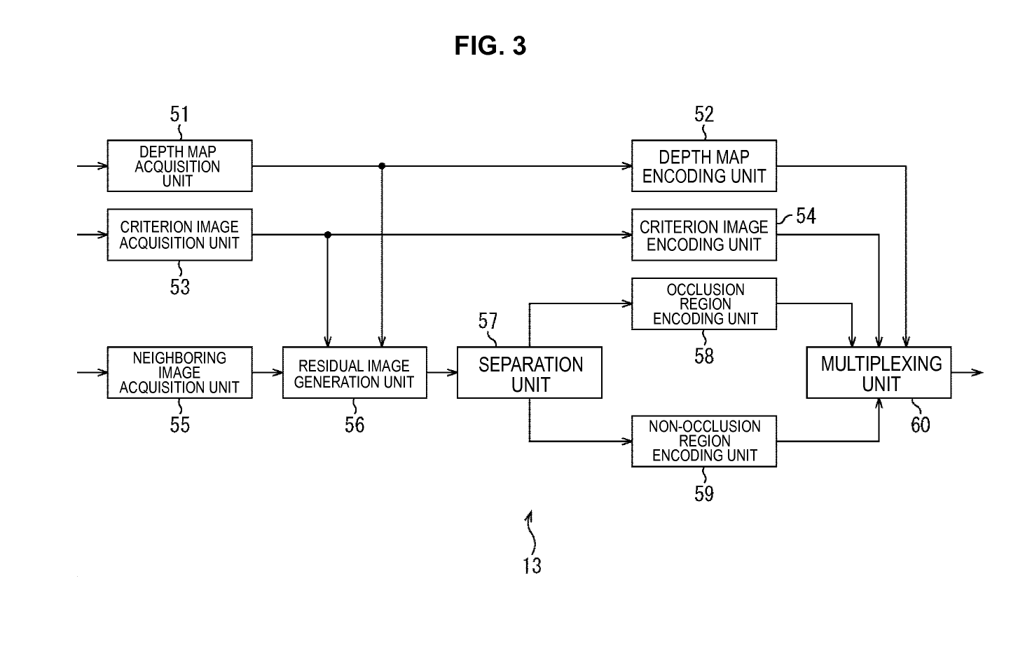

FIG. 3 is a block diagram illustrating an example of the configuration of the encoding device 13 in FIG. 1.

The encoding device 13 in FIG. 3 includes a depth map acquisition unit 51, a depth map encoding unit 52, a criterion image acquisition unit 53, a criterion image encoding unit 54, a neighboring image acquisition unit 55, a residual image generation unit 56, and a separation unit 57. The encoding device 13 further includes an occlusion region encoding unit 58, a non-occlusion region encoding unit 59, and a multiplexing unit 60.

The depth map acquisition unit 51 of the encoding device 13 acquires the depth map supplied from the generation device 12 and supplies the depth map to the depth map encoding unit 52 and the residual image generation unit 56. The depth map encoding unit 52 performs the lossless encoding on the depth map supplied from the depth map acquisition unit 51 and supplies the encoded data obtained as the result to the multiplexing unit 60.

The criterion image acquisition unit 53 acquires the image of the criterion viewpoint supplied from the generation device 12 and supplies the image of the criterion viewpoint to the criterion image encoding unit 54 and the residual image generation unit 56. The criterion image encoding unit 54 performs the lossless encoding on the image of the criterion viewpoint supplied from the criterion image acquisition unit 53 and supplies the encoded data obtained as the result to the multiplexing unit 60.

The neighboring image acquisition unit 55 acquires the image of the neighboring viewpoint supplied from the generation device 12 and supplies the image of the neighboring viewpoint to the residual image generation unit 56.

The residual image generation unit 56 generates the predicted image of the neighboring viewpoint by moving each pixel of the image of the criterion viewpoint supplied from the criterion image acquisition unit 53 based on the depth map supplied from the depth map acquisition unit 51.

For the non-occlusion region of the image of the neighboring viewpoint, the residual image generation unit 56 generates the difference between the image of the neighboring viewpoint supplied from the neighboring image acquisition unit 55 and the predicted image of the neighboring viewpoint and supplies the difference to the separation unit 57. The residual image generation unit 56 supplies the image of the neighboring viewpoint of the occlusion region to the separation unit 57 without change.

The separation unit 57 supplies the image of the neighboring viewpoint of the occlusion region supplied from the residual image generation unit 56 to the occlusion region encoding unit 58. The separation unit 57 supplies the difference of the non-occlusion region supplied from the residual image generation unit 56 to the non-occlusion region encoding unit 59.

The occlusion region encoding unit 58 performs the lossy encoding on the image of the neighboring viewpoint of the occlusion region supplied from the separation unit 57 and supplies the encoded data obtained as the result to the multiplexing unit 60.

The non-occlusion region encoding unit 59 performs the lossless encoding on the difference of the non-occlusion region supplied from the separation unit 57 and supplies the encoded data obtained as the result to the multiplexing unit 60.

The multiplexing unit 60 generates the encoded stream by multiplexing the encoded data of the depth map, the image of the criterion viewpoint, the image of the neighboring viewpoint of the occlusion region, and the difference of the non-occlusion region. The multiplexing unit 60 functions as a transmission unit and transmits the encoded stream to the decoding device 14.

(Description of Generation of Predicted Image)

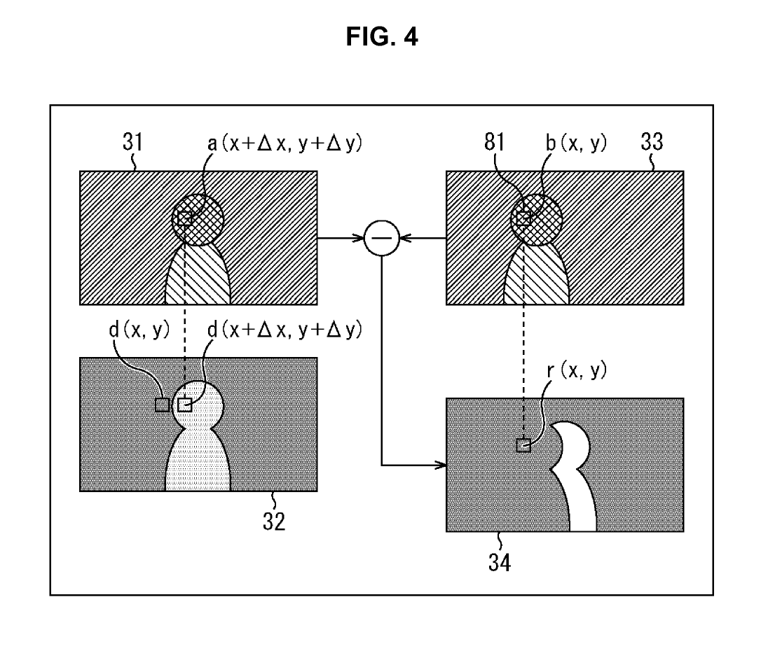

FIG. 4 is a diagram for describing generation of a predicted image by the residual image generation unit 56.

In FIG. 4, the same reference numerals the same reference numerals are given to the same constituent elements as those in FIG. 2. The repeated description will be properly omitted.

The value of the depth map 32 of the criterion viewpoint is a value corresponding to a disparity amount between the image 31 of the criterion viewpoint and the image 33 of the neighboring viewpoint. A disparity amount Δx(x, y) of a position (x, y) in the horizontal direction a disparity amount Δy(x, y) of the position (x, y) in the vertical direction are expressed as in the following equation (1) based on a value d(x, y) of the position (x, y) of the depth map 32.

Δx(x,y)=C1*d(x,y),Δy(x,y)=C2*d(x,y) (1)

In equation (1), C1 and C2 are coefficients used to convert a value of the depth map obtained by alignment (a base-line length, a direction, or the like) of the cameras 11 and the definition of the value of the depth map into a disparity amount.

When a pixel at a position (x, y) of the image 33 of the neighboring viewpoint is a pixel of the non-occlusion region, the position of a pixel of the image 31 of the criterion viewpoint corresponding to that pixel can be expressed as a position (x+Δx(x, y), y+Δy(x, y)) using disparity amounts Δx and Δy. Accordingly, the pixel at the position (x+Δx(x, y), y+Δy(x, y)) of the image 31 of the criterion viewpoint is moved and is considered to be a pixel at a position (x, y) of the predicted image of the neighboring viewpoint.

A difference r(x, y) between a pixel value a(x+Δx(x, y), y+Δy(x, y)) of the pixel at the position (x+Δx(x, y), y+Δy(x, y)) of the image 31, which is a pixel value of a pixel at the position (x, y) of the predicted image of the neighboring viewpoint generated in this way, and a pixel value b(x, y) of a pixel at a position (x, y) of the image 33 is expressed by the following equation (2).

r(x,y)=b(x,y)−a(x+Δx(x,y),y+Δy(x,y)) (2)

For the non-occlusion region, the difference r(x, y) is subjected to the lossless encoding.

On the other hand, when a pixel at a position (x, y) of the image 33 of the neighboring viewpoint is a pixel of the occlusion region, a pixel of the image 31 of the criterion viewpoint corresponding to that pixel is not present. Accordingly, a pixel value of the occlusion region of the predicted image of the neighboring viewpoint is not generated. Thus, the pixel at the position (x, y) of the image 33 of the criterion viewpoint is subjected to the lossy encoding.

(Description of Process of Encoding Device)

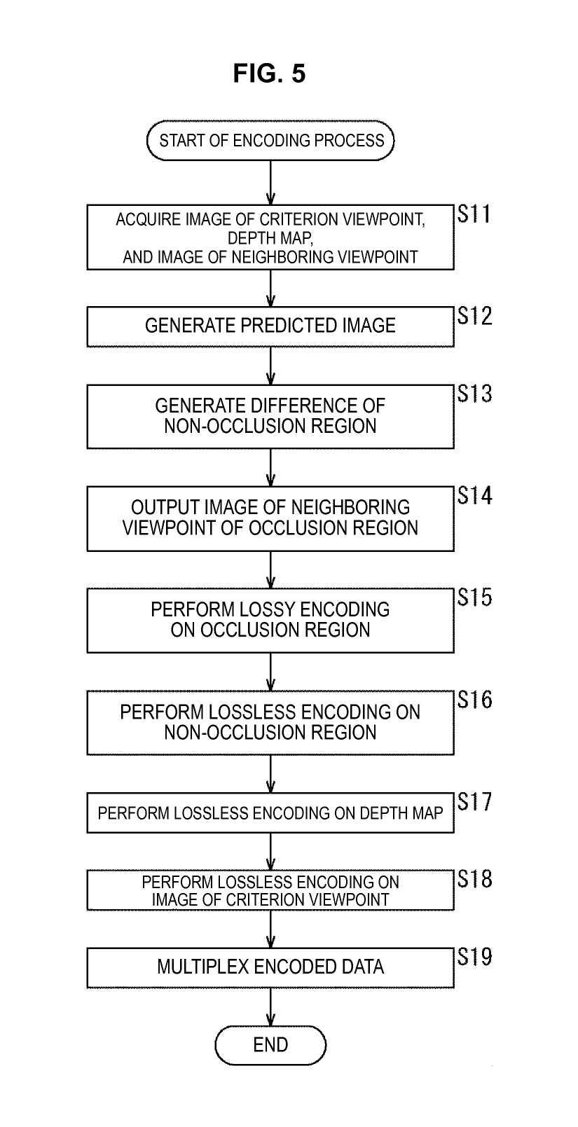

FIG. 5 is a flowchart for describing the encoding process of the encoding device 13 in FIG. 3. The encoding process starts when the image of the criterion image, the depth map, and the image of the neighboring viewpoint are supplied from the generation device 12 in FIG. 1.

In step S11 of FIG. 5, the criterion image acquisition unit 53 of the encoding device 13 acquires the image of the criterion viewpoint supplied from the generation device 12 and supplies the image of the criterion viewpoint to the criterion image encoding unit 54 and the residual image generation unit 56. The depth map acquisition unit 51 acquires the depth map supplied from the generation device 12 and supplies the depth map to the depth map encoding unit 52 and the residual image generation unit 56. The neighboring image acquisition unit 55 acquires the image of the neighboring viewpoint supplied from the generation device 12 and supplies the image of the neighboring viewpoint to the residual image generation unit 56.

In step S12, the residual image generation unit 56 generates the predicted image of the neighboring viewpoint by moving each pixel of the image of the criterion viewpoint supplied from the criterion image acquisition unit 53 based on the depth map supplied from the depth map acquisition unit 51.

In step S13, the residual image generation unit 56 generates the difference between the image of the neighboring viewpoint supplied from the neighboring image acquisition unit 55 and the predicted image of the neighboring viewpoint for the non-occlusion region and supplies the difference to the separation unit 57. The separation unit 57 supplies the difference of the non-occlusion region supplied from the residual image generation unit 56 to the non-occlusion region encoding unit 59.

In step S14, the residual image generation unit 56 outputs the image of the neighboring viewpoint of the occlusion region without change to the occlusion region encoding unit 58 via the separation unit 57.

In step S15, the occlusion region encoding unit 58 performs the lossy encoding on the image of the neighboring viewpoint of the occlusion region supplied from the separation unit 57 and supplies the encoded data obtained as the result to the multiplexing unit 60.

In step S16, the non-occlusion region encoding unit 59 performs the lossless encoding on the difference of the non-occlusion region supplied from the separation unit 57 and supplies the encoded data obtained as the result to the multiplexing unit 60.

In step S17 the depth map encoding unit 52 performs the lossless encoding on the depth map supplied from the depth map acquisition unit 51 and supplies the encoded data obtained as the result to the multiplexing unit 60.

In step S18, the criterion image encoding unit 54 performs the lossless encoding on the image of the criterion viewpoint supplied from the criterion image acquisition unit 53 and supplies the encoded data obtained as the result to the multiplexing unit 60.

In step S19, the multiplexing unit 60 generates the encoded stream by multiplexing the encoded data of the depth map, the image of the criterion viewpoint, the image of the neighboring viewpoint of the occlusion region, and the difference of the non-occlusion region. The multiplexing unit 60 transmits the encoded stream to the decoding device 14, and then the process ends.

(Example of Configuration of Decoding Device)

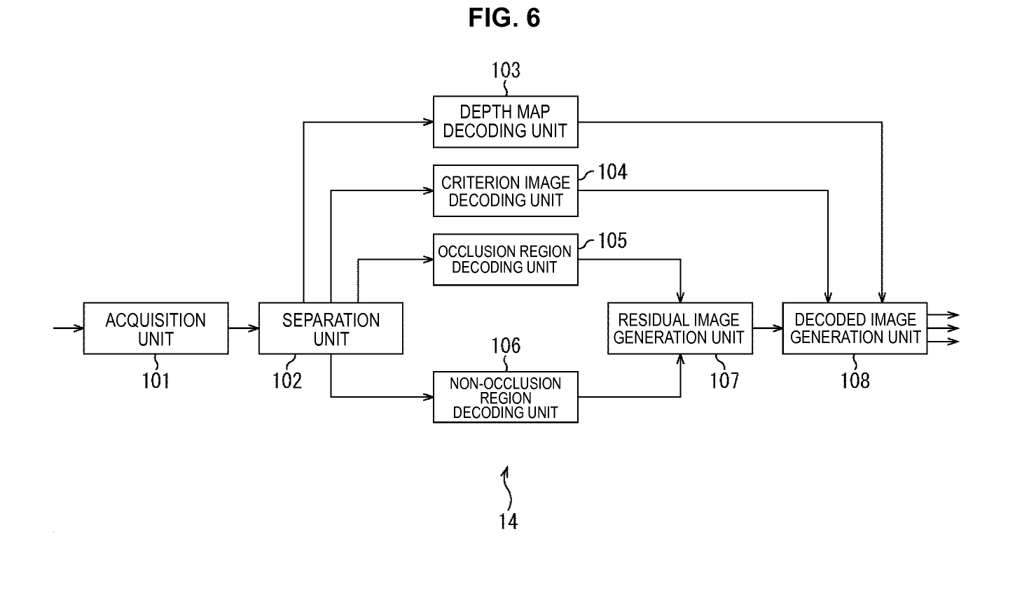

FIG. 6 is a block diagram illustrating an example of the configuration of the decoding device 14 in FIG. 1.

The decoding device 14 in FIG. 6 includes an acquisition unit 101, a separation unit 102, a depth map decoding unit 103, a criterion image decoding unit 104, an occlusion region decoding unit 105, and a non-occlusion region decoding unit 106. The decoding device 14 further includes a residual image generation unit 107 and a decoded image generation unit 108.

The acquisition unit 101 of the decoding device 14 functions as a reception unit, acquires the encoded stream transmitted from the encoding device 13, and supplies the encoded stream to the separation unit 102.

The separation unit 102 separates the encoded stream supplied from the acquisition unit 101 into the encoded data of the image of the neighboring viewpoint of the occlusion region, the difference of the non-occlusion region, the image of the criterion viewpoint, and the depth map. The separation unit 102 supplies the encoded data of the depth map to the depth map decoding unit 103 and supplies the encoded data of the image of the criterion viewpoint to the criterion image decoding unit 104.

The separation unit 102 supplies the encoded data of the image of the neighboring viewpoint of the occlusion region to the occlusion region decoding unit 105. The separation unit 102 supplies the encoded data of the difference of the non-occlusion region to the non-occlusion region decoding unit 106.

The depth map decoding unit 103 performs lossless decoding on the encoded data of the depth map supplied from the separation unit 102. The depth map decoding unit 103 supplies the depth map obtained as the result of the lossless decoding to the decoded image generation unit 108.

The criterion image decoding unit 104 performs the lossless decoding on the encoded data of the image of the criterion viewpoint supplied from the separation unit 102. The criterion image decoding unit 104 supplies the image of the criterion viewpoint obtained as the result of the lossless decoding to the decoded image generation unit 108.

The occlusion region decoding unit 105 performs lossy decoding on the encoded data of the image of the neighboring viewpoint of the occlusion region supplied from the separation unit 102. The occlusion region decoding unit 105 supplies the image of the neighboring viewpoint of the occlusion region obtained as the result of the lossy decoding to the residual image generation unit 107.

The non-occlusion region decoding unit 106 performs lossless decoding of higher quality than lossy decoding on the encoded data of the difference of the non-occlusion region supplied from the separation unit 102. The non-occlusion region decoding unit 106 supplies the difference of the non-occlusion region obtained as the result of the lossless decoding to the residual image generation unit 107.

The residual image generation unit 107 generates a residual image by combining the image of the neighboring viewpoint of the occlusion region supplied from the occlusion region decoding unit 105 and the difference of the non-occlusion region supplied from the non-occlusion region decoding unit 106. The residual image generation unit 107 supplies the residual image to the decoded image generation unit 108.

The decoded image generation unit 108 outputs the depth map supplied from the depth map decoding unit 103. The decoded image generation unit 108 outputs the image of the criterion viewpoint supplied from the criterion image decoding unit 104. The decoded image generation unit 108 generates the predicted image by moving each pixel of the image of the criterion viewpoint based on the depth image, as in the residual image generation unit 56 in FIG. 3. The decoded image generation unit 108 generates the image of the neighboring viewpoint by adding the predicted image to the residual image. The decoded image generation unit 108 outputs the image of the neighboring viewpoint.

(Description of Process of Decoding Device)

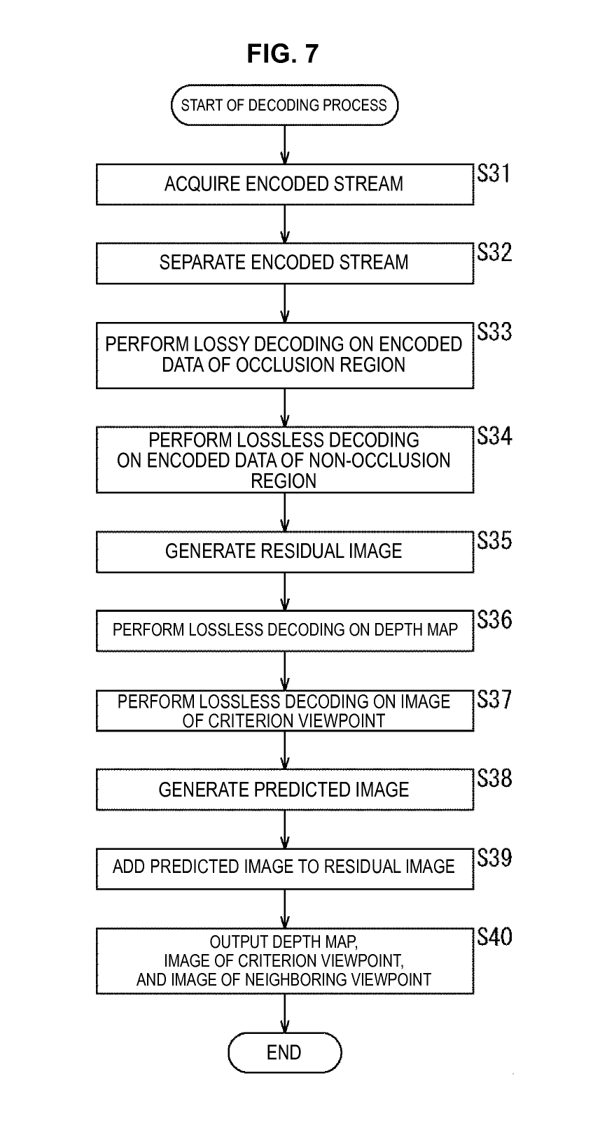

FIG. 7 is a flowchart for describing the decoding process of the decoding device 14 in FIG. 6. The decoding process starts, for example, when the encoded stream is transmitted from the encoding device 13.

In step S31 of FIG. 7, the acquisition unit 101 of the decoding device 14 acquires the encoded stream transmitted from the encoding device 13 and supplies the encoded stream to the separation unit 102.

In step S32, the separation unit 102 separates the encoded stream supplied from the acquisition unit 101 into the encoded data of the image of the neighboring viewpoint of the occlusion region, the difference of the non-occlusion region, the image of the criterion viewpoint, and the depth map.

The separation unit 102 supplies the encoded data of the depth map to the depth map decoding unit 103 and supplies the encoded data of the image of the criterion viewpoint to the criterion image decoding unit 104. The separation unit 102 supplies the encoded data of the image of the neighboring viewpoint of the occlusion region to the occlusion region decoding unit 105. The separation unit 102 supplies the encoded data of the difference of the non-occlusion region to the non-occlusion region decoding unit 106.

In step S33, the occlusion region decoding unit 105 performs the lossy decoding on the encoded data of the image of the neighboring viewpoint of the occlusion region supplied from the separation unit 102. The occlusion region decoding unit 105 supplies the image of the neighboring viewpoint of the occlusion region obtained as the result of the lossy decoding to the residual image generation unit 107.

In step S34, the non-occlusion region decoding unit 106 performs the lossless decoding on the encoded data of the difference of the non-occlusion region supplied from the separation unit 102. The non-occlusion region decoding unit 106 supplies the difference of the non-occlusion region obtained as the result of the lossless decoding to the residual image generation unit 107.

In step S35, the residual image generation unit 107 generates the residual image by combining the image of the neighboring viewpoint of the occlusion region supplied from the occlusion region decoding unit 105 and the difference of the non-occlusion region supplied from the non-occlusion region decoding unit. The residual image generation unit 107 supplies the residual image to the decoded image generation unit 108.

In step S36, the depth map decoding unit 103 performs the lossless decoding on the encoded data of the depth map supplied from the separation unit 102. The depth map decoding unit 103 supplies the depth map obtained as the result of the lossless decoding to the decoded image generation unit 108.

In step S37, the criterion image decoding unit 104 performs the lossless decoding on the encoded data of the image of the criterion viewpoint supplied from the separation unit 102. The criterion image decoding unit 104 supplies the image of the criterion viewpoint obtained as the result of the lossless decoding to the decoded image generation unit 108.

In step S38, the decoded image generation unit 108 generates the predicted image by moving each pixel of the image of the criterion viewpoint based on the depth map, as in the residual image generation unit 56 in FIG. 3. In step S39, the decoded image generation unit 108 generates the image of the neighboring viewpoint by adding the predicted image to the residual image.

In step S40, the decoded image generation unit 108 outputs the depth image, the image of the criterion viewpoint, and the image of the neighboring viewpoint. Then, the process ends.

In the image processing system 10, as described above, the encoding device 13 performs the lossless encoding on the difference of the non-occlusion region of the image of the neighboring viewpoint and performs the lossy encoding on the occlusion region. Accordingly, it is possible to perform the highly efficient encoding while maintaining the image quality of the image of the neighboring viewpoint.

The decoding device 14 performs the lossless decoding on the difference of the non-occlusion region of the neighboring viewpoint and performs the lossy decoding on the occlusion region. Accordingly, it is possible to decode the encoded stream subjected to the highly efficient encoding while the encoding device 13 maintains the image quality of the image of the neighboring viewpoint.

### Second Embodiment

### Example of Configuration of Image Processing System of Second Embodiment

The configuration of an image processing system of a second embodiment to which the present disclosure is applied is the same as that of the image processing system 10 in FIG. 1 except for an encoding device 120 and a decoding device 160. Thus, only the encoding device 120 and the decoding device 160 will be described below.

(Example of Configuration of Encoding Device)

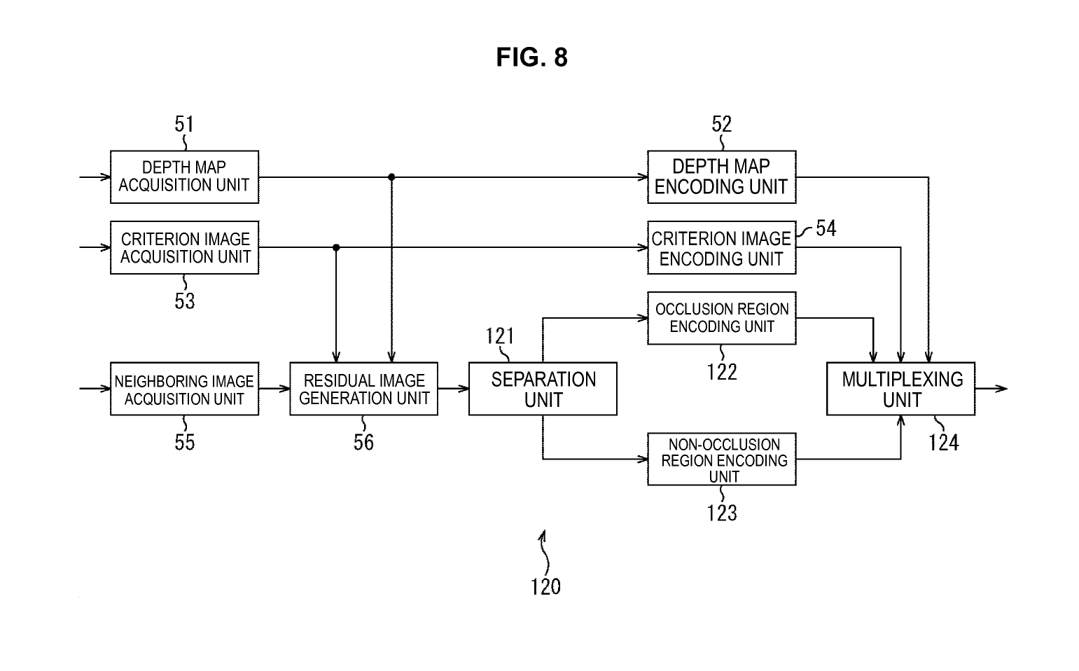

FIG. 8 is a diagram illustrating an example of the configuration of the encoding device of the image processing system of the second embodiment to which the present disclosure is applied.

The same reference numerals are given to the same constituent elements as those of the configuration of FIG. 3 in constituent elements illustrated in FIG. 8. The repeated description will be properly omitted.

The configuration of the encoding device 120 in FIG. 8 is different from the configuration of the encoding device 13 in FIG. 3 in that a separation unit 121, an occlusion region encoding unit 122, a non-occlusion region encoding unit 123, and a multiplexing unit 124 are provided instead of the separation unit 57, the occlusion region encoding unit 58, the non-occlusion region encoding unit 59, and the multiplexing unit 60. The encoding device 120 performs lossy encoding on a relatively large difference among differences of the non-occlusion region along with the occlusion region.

Specifically, the separation unit 121 of the encoding device 120 supplies the image of the neighboring viewpoint of the occlusion region supplied from the residual image generation unit 56 to the occlusion region encoding unit 122. The separation unit 121 supplies a difference equal to or greater than a threshold value in the difference of the non-occlusion region supplied from the residual image generation unit 56 as a large difference to the occlusion region encoding unit 122. The separation unit 121 supplies a difference less than the threshold value in the difference of the non-occlusion region as a small difference to the non-occlusion region encoding unit 123.

The occlusion region encoding unit 122 performs the lossy encoding on the image of the neighboring viewpoint of the occlusion region and the large difference supplied from the separation unit 121. The occlusion region encoding unit 122 supplies the encoded data of the image of the neighboring viewpoint of the occlusion region and the large difference obtained as the result to the multiplexing unit 124.

The non-occlusion region encoding unit 123 performs the lossless encoding on the small difference supplied from the separation unit 121 and supplies the encoded data obtained as the result to the multiplexing unit 124.

The multiplexing unit 124 multiplexes the encoded data of the image of the neighboring viewpoint of the occlusion region and the large difference obtained by the result of the lossy encoding and the encoded data of the depth map, the image of the criterion viewpoint, and the small difference obtained as the result of the lossless encoding. The multiplexing unit 124 functions as a transmission unit and transmits the encoded stream obtained as the multiplexing result to the decoding process 160 to be described below.

(Description of Separation of Difference of Non-Occlusion Region)

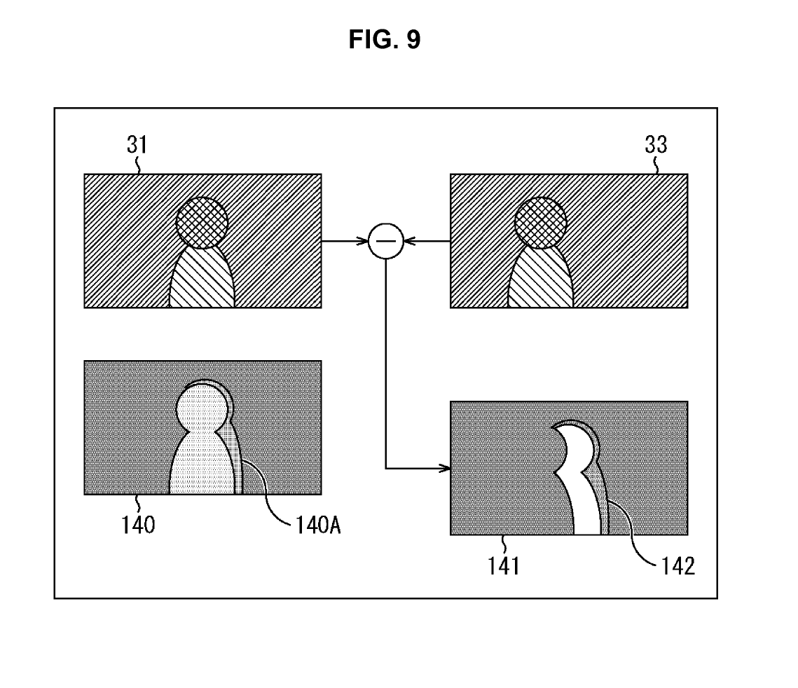

FIG. 9 is a diagram for describing separation of a difference of a non-occlusion region by the separation unit 121 in FIG. 8.

In FIG. 9, the same reference numerals are given to the same constituent elements as those in FIG. 4. The repeated description will be properly omitted.

In the example of FIG. 9, a right-side boundary region 140A between a background and a person, who is a foreground, of a depth map 140 of the criterion viewpoint has a value not indicating the position of the background in a depth direction due to a cause of noise in an image captured by the camera 11, a generation error of the depth map by the generation device 12, or the like.

Accordingly, a predicted image of the neighboring viewpoint generated based on the depth map 140, as described with reference to FIG. 4, is considerably different from an image 33 of the neighboring viewpoint in the boundary region 140A. As a result, a difference of a region 142 corresponding to the boundary region 140A increases in a difference 141 of the non-occlusion region. Thus, in this case, for example, the difference of the region 142 in the difference 141 is considered to be a large difference and a difference of a region other than the region 142 in the difference 141 is considered to be a small difference.

(Description of Process of Encoding Device)

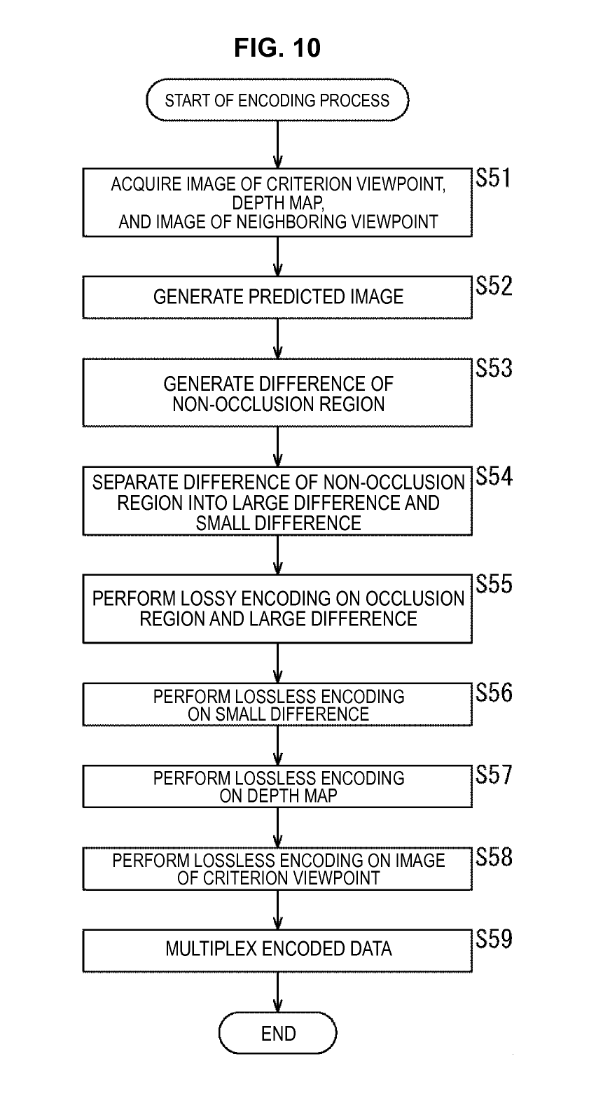

FIG. 10 is a flowchart for describing an encoding process of the encoding device 120 in FIG. 8. The encoding process starts when the image of the criterion viewpoint, the depth map, and the image of the neighboring viewpoint are supplied from the generation device 12.

Since processes of step S51 to step S53 of FIG. 10 are the same as the processes of step S11 to step S13 of FIG. 5, the description thereof will be omitted.

In step S54, the separation unit 121 of the encoding device 120 separates a difference equal to or greater than the threshold value in the difference of the non-occlusion region supplied from the residual image generation unit 56 as a large difference and separates a difference less than the threshold value as a small difference. The separation unit 121 supplies the large difference to the occlusion region encoding unit 122 and supplies the small difference to the non-occlusion region encoding unit 123.

In step S55, the occlusion region encoding unit 122 performs the lossy encoding on the image of the neighboring viewpoint of the occlusion region supplied from the separation unit 121 and the large difference. The occlusion region encoding unit 122 supplies the encoded data obtained as the result to the multiplexing unit 124.

In step S56, the non-occlusion region encoding unit 123 performs the lossless encoding on the small difference supplied from the separation unit 121 and supplies the encoded data obtained as the result to the multiplexing unit 124.

Since processes of step S57 and step S58 are the same as the processes of step S17 and step S18 of FIG. 10, the description thereof will be omitted.

In step S59, the multiplexing unit 124 multiplexes the encoded data of the image of the neighboring viewpoint of the occlusion region and the large difference obtained as the result of the lossy encoding and the encoded data of the depth map, the image of the criterion viewpoint, and the small difference obtained as the result of the lossless encoding. The multiplexing unit 124 transmits the encoded stream obtained as the multiplexing result to the decoding device 160 to be described below, and then the process ends.

(Example of Configuration of Decoding Device)

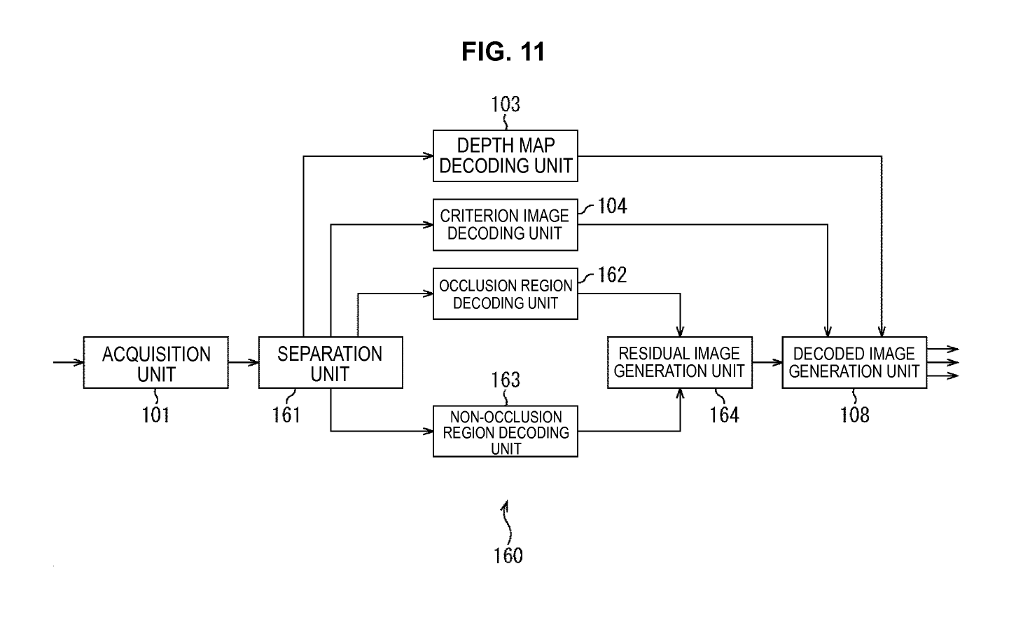

FIG. 11 is a block diagram illustrating an example of the configuration of the decoding device of the image processing system of the second embodiment to which the present disclosure is applied.

The same reference numerals are given to the same constituent elements as those of the configuration of FIG. 6 in constituent elements illustrated in FIG. 11. The repeated description will be properly omitted.

The configuration of the decoding device 160 in FIG. 11 is different from the configuration of the decoding device 14 in FIG. 6 in that a separation unit 161, an occlusion region decoding unit 162, a non-occlusion region decoding unit 163, and a residual image generation unit 164 are provided instead of the separation unit 102, the occlusion region decoding unit 105, the non-occlusion region decoding unit 106, and the residual image generation unit 107.

The separation unit 161 of the decoding device 160 separates the encoded stream supplied from the acquisition unit 101 into the encoded data of the image of the neighboring viewpoint of the occlusion region, the large difference, the small difference, and the image of the criterion viewpoint, and the depth map. The separation unit 161 supplies the encoded data of the depth map to the depth map decoding unit 103 and supplies the encoded data of the image of the criterion viewpoint to the criterion image decoding unit 104.

The separation unit 161 supplies the encoded data of the image of the neighboring viewpoint of the occlusion region and the large difference to the occlusion region decoding unit 162. The separation unit 161 supplies the encoded data of the small difference to the non-occlusion region decoding unit 163.

The occlusion region decoding unit 162 performs the lossy decoding on the encoded data of the image of the neighboring viewpoint of the occlusion region and the large difference supplied from the separation unit 161. The occlusion region decoding unit 162 supplies the image of the neighboring viewpoint of the occlusion region and the large difference obtained as the result of the lossy decoding to the residual image generation unit 164.

The non-occlusion region decoding unit 163 performs the lossless decoding on the encoded data of the small difference supplied from the separation unit 161. The non-occlusion region decoding unit 163 supplies the small difference obtained as the result of the lossless decoding to the residual image generation unit 164.

The residual image generation unit 164 generates the residual image by combining the image of the neighboring viewpoint of the occlusion region and the large difference supplied from the occlusion region decoding unit 162 and the small difference supplied from the non-occlusion region decoding unit 163. The residual image generation unit 164 supplies the residual image to the decoded image generation unit 108.

(Description of Process of Decoding Device)

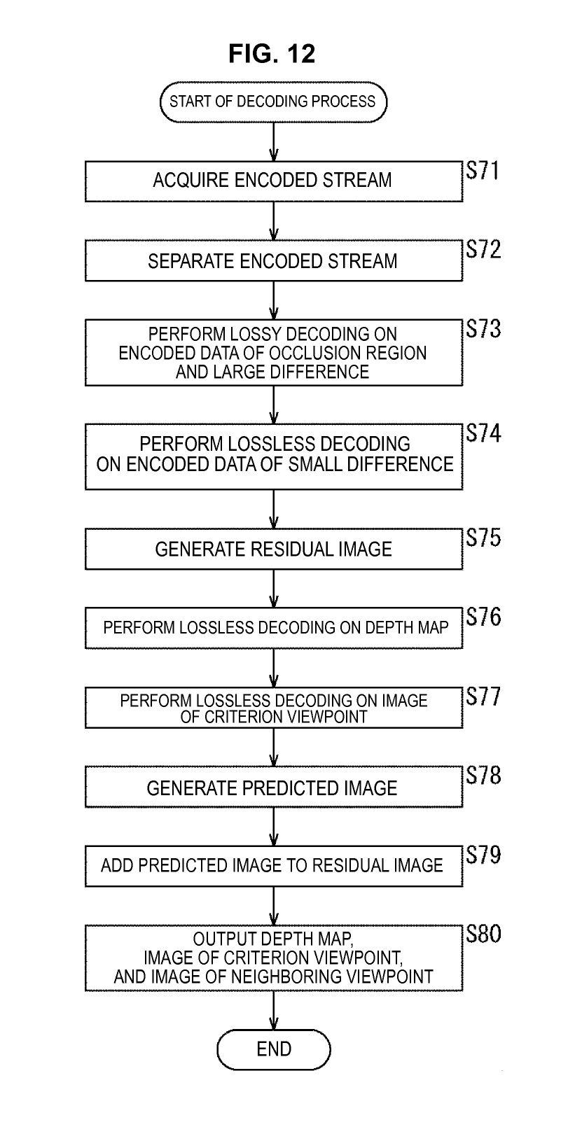

FIG. 12 is a flowchart for describing the decoding process of the decoding device 160 in FIG. 11. The decoding process starts, for example, when the encoded stream is transmitted from the encoding device 120.

In step S71 of FIG. 12, the acquisition unit 101 of the decoding device 160 acquires the encoded stream transmitted from the encoding device 120 and supplies the encoded stream to the separation unit 161.

In step S72, the separation unit 161 separates the encoded stream supplied from the acquisition unit 101 into the encoded data of the image of the neighboring viewpoint of the occlusion region, the large difference, the small difference, the image of the criterion viewpoint, and the depth map. The separation unit 161 supplies the encoded data of the depth map to the depth map decoding unit 103 and supplies the encoded data of the image of the criterion viewpoint to the criterion image decoding unit 104.

The separation unit 161 supplies the encoded data of the image of the neighboring viewpoint of the occlusion region and the large difference to the occlusion region decoding unit 162. The separation unit 161 supplies the encoded data of the small difference to the non-occlusion region decoding unit 163.

In step S73, the occlusion region decoding unit 162 performs the lossy decoding on the encoded data of the image of the neighboring viewpoint of the occlusion region and the large difference supplied from the separation unit 161. The occlusion region decoding unit 162 supplies the image of the neighboring viewpoint of the occlusion region and the large difference obtained as the result of the lossy decoding to the residual image generation unit 164.

In step S74, the non-occlusion region decoding unit 163 performs the lossless decoding on the encoded data of the small difference supplied from the separation unit 161. The non-occlusion region decoding unit 163 supplies the small difference obtained as the result of the lossless decoding to the residual image generation unit 164.

In step S75, the residual image generation unit 164 generates the residual image by combining the image of the neighboring viewpoint of the occlusion region and the large difference supplied from the occlusion region decoding unit 162 and the small difference of the non-occlusion region supplied from the non-occlusion region decoding unit 163. The residual image generation unit 164 supplies the residual image to the decoded image generation unit 108.

Since processes of step S76 to step S80 are the same as the processes of step S36 to step S40 of FIG. 7, the description thereof will be omitted.

As described above, the encoding device 120 performs the lossless encoding on the small difference and performs the lossy encoding on the occlusion region and the large difference. Accordingly, it is possible to perform the highly efficient encoding while maintaining the image quality of the image of the neighboring viewpoint. Further, since the large difference is subjected to the lossy encoding in the difference of the non-occlusion region, the encoding efficiency is improved more than in the encoding device 13.

The decoding device 160 performs the lossless decoding on the small difference and performs the lossy decoding on the occlusion region and the large difference. Accordingly, it is possible to decode the encoded stream subjected to the highly efficient encoding while the encoding device 120 maintains the image quality of the image of the neighboring viewpoint.

<Examples of Encoding Scheme>

(First Example of Encoding Scheme)

In the above description, the occlusion region has been subjected to the lossy encoding and the non-occlusion region has been subjected to the lossless encoding, but the encoding schemes are not limited thereto.

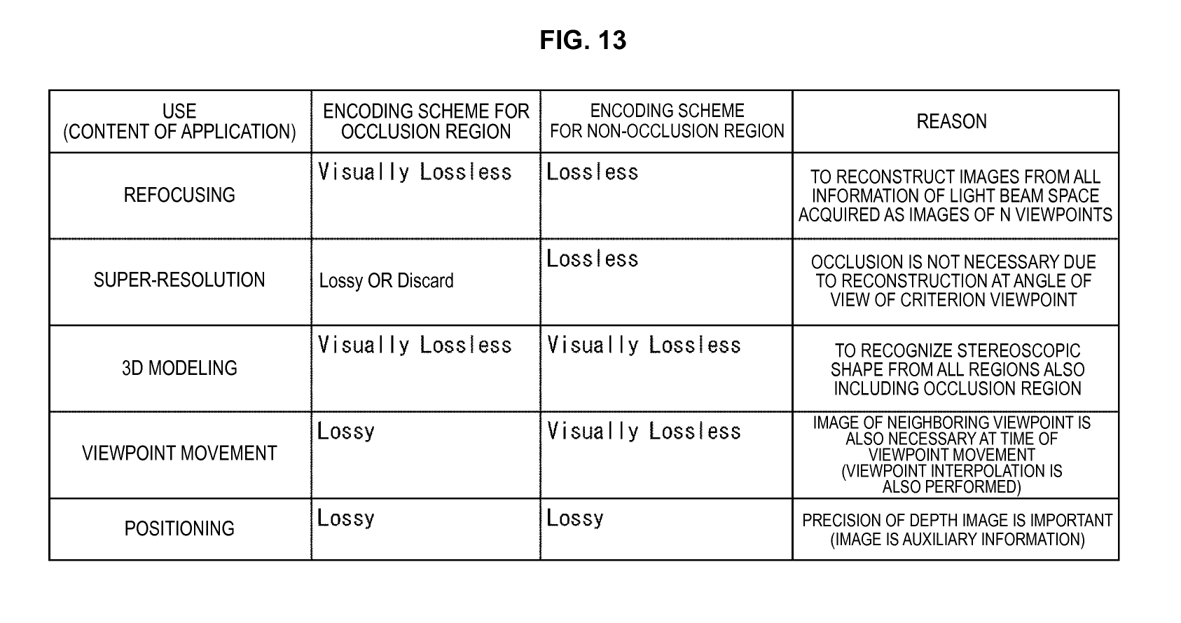

FIG. 13 is a diagram illustrating a first example of a relation between the uses of the depth map and the images of N viewpoints output from the decoding device 14 (160) and the encoding schemes of the occlusion region and the non-occlusion region.

As illustrated in FIG. 13, when a use is a refocusing process of generating images by changing focus distances of the cameras 11 using images of N viewpoints, the images are reconstructed using all of the information regarding a light beam space (light field) acquired as the images of the N viewpoints. Accordingly, both of an occlusion region and a non-occlusion region are important.

Accordingly, in this case, a visually lossless scheme is used as an encoding scheme for the occlusion region. The visually lossless scheme is a high-quality encoding scheme in which deterioration in image quality may not be perceived despite a lossy encoding scheme. Further, a lossless scheme is used as an encoding scheme for the non-occlusion region.

That is, for the non-occlusion region, the same image can be generated by moving the image of the criterion viewpoint. Therefore, in an encoding device of the related art, a small difference between the viewpoints of the non-occlusion region is not transmitted in order to improve encoding efficiency.

However, when the use is the refocusing process, the difference between the viewpoints of the non-occlusion region is important since the difference is information indicating characteristics such as texture, gloss, and the like of each viewpoint. Accordingly, in an embodiment of the present disclosure, the difference between the viewpoints of the non-occlusion region is encoded according to a lossless scheme. As a result, since a subtle difference in vision between viewpoints does not deteriorate and is retained in a decoded image, the refocusing process can be performed with high precision.

When the use is super-resolution processing performed by matching pixel values of an image of each viewpoint in units of sub-pixels using a depth map, a super-resolution image is reconstructed at an angle of view of a criterion viewpoint. Accordingly, a non-occlusion region is important, but an occlusion region is not necessary.

Accordingly, in this case, a lossy scheme is used as an encoding scheme for the occlusion region or the occlusion region is not encoded (is discarded). The lossy scheme is a lossy encoding scheme of lower image quality than the visually lossless scheme and is an encoding scheme in which deterioration in image quality can be perceived. As the lossy scheme, there are a Joint Photographic Experts Group (JPEG) scheme and the like. A lossless scheme is used as an encoding scheme for the non-occlusion region.

When the use is a 3D modeling process of generating a 3D modeling image of a subject from images of N viewpoints, a stereoscopic shape of the subject is recognized from all of the regions also including an occlusion region. Accordingly, both of the occlusion region and a non-occlusion region are important. Thus, a visually lossless scheme is used as an encoding scheme for the occlusion region and the non-occlusion region.

When the use is a viewpoint movement process of moving a viewpoint of an output image by performing viewpoint interpolation, as necessary, an image of a neighboring viewpoint is necessary. Accordingly, in this case, a lossy scheme is used as an encoding scheme for an occlusion region and a visually lossless scheme is used as an encoding scheme for a non-occlusion region.

When the use is a positioning process of detecting a distance from the camera 11 to a subject in a depth direction using a depth map, precision of the depth map is important and an image of each viewpoint is not important. Accordingly, in this case, a lossy scheme is used as an encoding scheme for both of an occlusion region and a non-occlusion region.

(Second Example of Encoding Scheme)

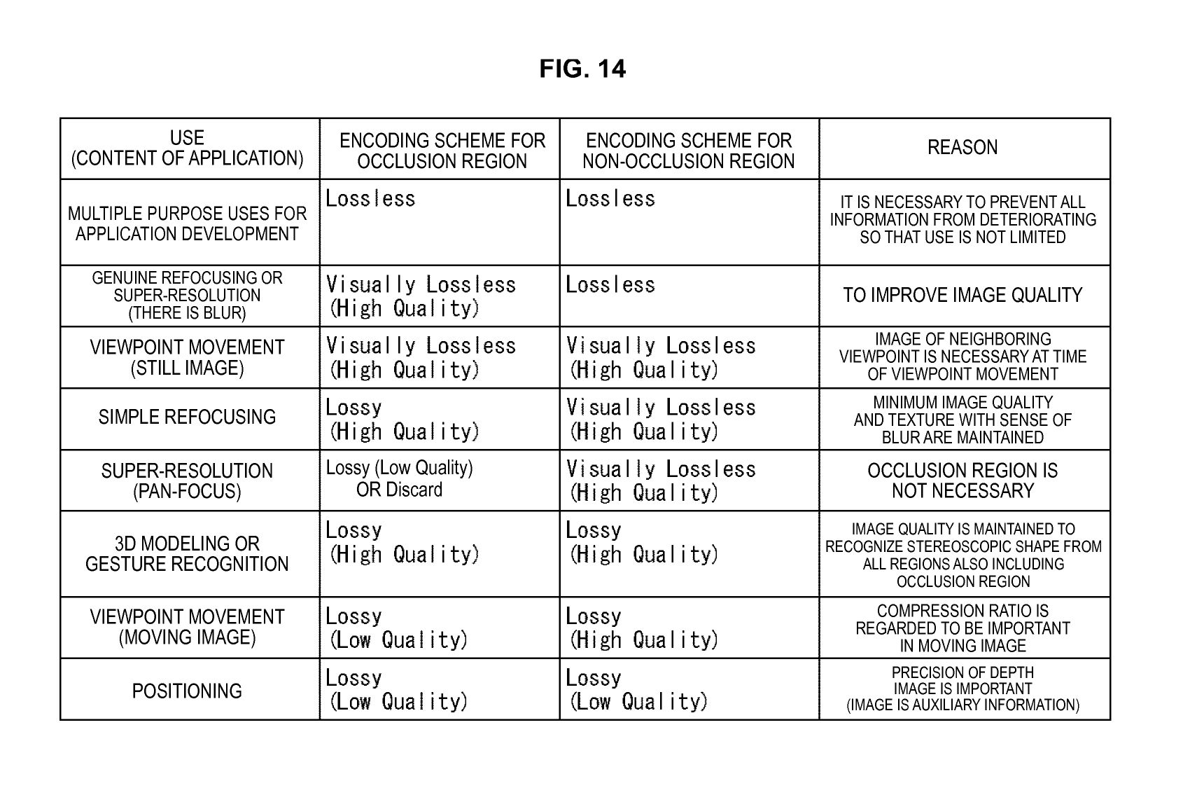

FIG. 14 is a diagram illustrating a second example of a relation between the uses of the depth map and the images of N viewpoints output from the decoding device 14 (160) and the encoding schemes of the occlusion region and the non-occlusion region.

As illustrated in FIG. 14, when the use is multiple purpose uses for newly developed applications, it is necessary not to limit the use. Accordingly, it is necessary to cause image quality not to deteriorate in both of an occlusion region and a non-occlusion region. Accordingly, in this case, lossless schemes are used as encoding schemes for both of the occlusion region and the non-occlusion region.

When the use is a genuine refocusing process or a super-resolution process of correcting blur, it is necessary to improve image quality of a reconstructed image. Accordingly, image quality of both of a non-occlusion region and an occlusion region important in the refocusing process and the super-resolution process for blur correction is relatively important. Thus, a lossless scheme is used as an encoding scheme for the non-occlusion region and a high-quality visually lossless scheme is used as an encoding scheme for the occlusion region.

When the use is a viewpoint movement process, both of an occlusion region and a non-occlusion region are important since an image of a neighboring viewpoint is necessary at the time of the viewpoint movement. When images of N viewpoints are still images, a data amount of an image of a neighboring viewpoint is small compared to a case of a moving image. Accordingly, when the use is a viewpoint movement process and the images of the N viewpoints are still images, high-quality visually lossless schemes are used as encoding schemes for both of the non-occlusion region and the occlusion region.

When the use is a simple refocusing process, both of a non-occlusion region and an occlusion region are important and it is necessary to maintain minimum image quality and texture with a sense of blur. Accordingly, a high-quality visually lossless scheme is used as an encoding scheme for the non-occlusion region and a high-quality lossy scheme is used as an encoding scheme for the occlusion region.

When the use is a super-resolution process of generating a pan-focus image, an occlusion region is not necessary since a super-resolution image is reconstructed at an angle of view of a criterion viewpoint. Accordingly, a high-quality visually lossless scheme is used as an encoding scheme for a non-occlusion region, but a low-quality lossy scheme is used as an encoding scheme for the occlusion region or the occlusion region is not encoded (is discarded).

When the use is a 3D modeling process or a gesture recognition process of recognizing a gesture of a subject, a stereoscopic shape of the subject is recognized from all of the regions also including an occlusion region. Accordingly, it is necessary to maintain image quality of the occlusion region as well as a non-occlusion region. Thus, high-quality lossy schemes are used as encoding schemes for the non-occlusion region and the occlusion region.

When the use is a viewpoint movement process, as described above, both of an occlusion region and a non-occlusion region are important since an image of a neighboring viewpoint is necessary at the time of the viewpoint movement. On the other hand, when images of N viewpoints are a moving image, a data amount of an image of a neighboring viewpoint is greater than in the case of a still image. Accordingly, when the use is a viewpoint movement process and the images of the N viewpoints are a moving image, a high-quality lossy scheme is used as an encoding scheme for the non-occlusion region and a low-quality lossy scheme is used as an encoding scheme for the occlusion region.

When the use is a positioning process, the precision of the depth map is important and an image of each viewpoint is not important. Accordingly, in this case, low-quality lossy schemes are used as encoding schemes for both of an occlusion region and a non-occlusion region.

The encoding schemes for an occlusion region and a non-occlusion region may be set by a user according to a use. Alternatively, the encoding device 13 (120) may determine a use so that the use can be set automatically.

A flag (information) indicating the encoding schemes for an occlusion region and a non-occlusion region may be transmitted from the encoding device 13 (120) to the decoding device 14 (160). In this case, the multiplexing unit 60 (124) sets the flag in, for example, a Sequence Parameter Set (SPS), a system layer, the header of a file format, or the like to transmit the flag. Then, the acquisition unit 101 receives the flag and the encoded data of the difference between the occlusion region and the non-occlusion region is decoded according to a decoding scheme corresponding to the encoding scheme indicated by the flag.

### Third Embodiment

### Configuration Example of Computer to which Present Technology is Applied

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

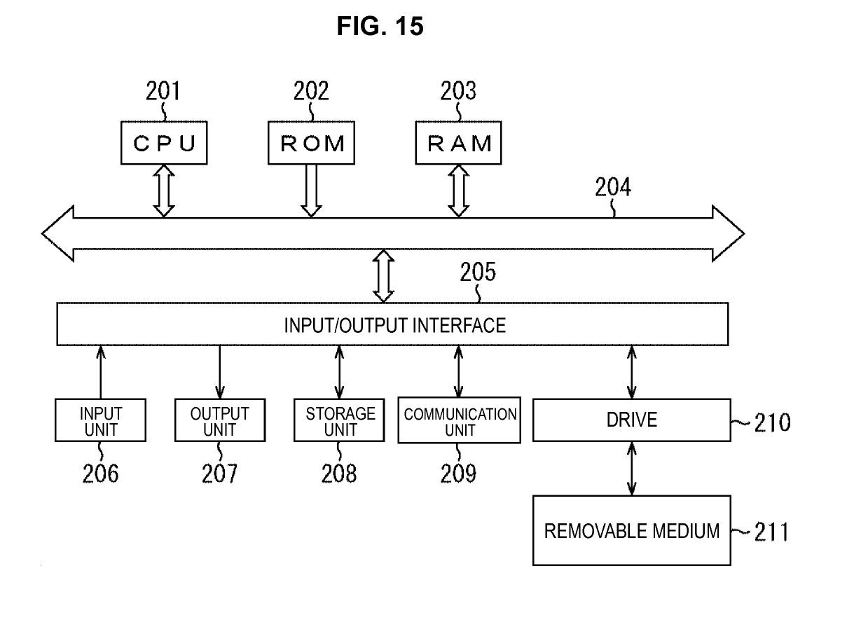

FIG. 15 is a block diagram showing an example configuration of the hardware of a computer that executes the series of processes described earlier according to a program.

In the computer, a central processing unit (CPU) 201, a read only memory (ROM) 202 and a random access memory (RAM) 203 are mutually connected by a bus 204.

An input/output interface 205 is also connected to the bus 204. An input unit 206, an output unit 207, a storage unit 208, a communication unit 209, and a drive 210 are connected to the input/output interface 205.

The input unit 206 is configured from a keyboard, a mouse, a microphone or the like. The output unit 207 is configured from a display, a speaker or the like. The storage unit 208 is configured from a hard disk, a non-volatile memory or the like. The communication unit 209 is configured from a network interface or the like. The drive 210 drives a removable medium 211 such as a magnetic disk, an optical disk, a magneto-optical disk, a semiconductor memory or the like.

In the computer configured as described above, the CPU 201 loads a program that is stored, for example, in the storage unit 208 onto the RAM 203 via the input/output interface 205 and the bus 204, and executes the program. Thus, the above-described series of processing is performed.

Programs to be executed by the computer (the CPU 201) are provided being recorded in the removable medium 211 which is a packaged medium or the like. Also, programs may be provided via a wired or wireless transmission medium, such as a local area network, the Internet or digital satellite broadcasting.

In the computer, by loading the removable medium 211 into the drive 210, the program can be installed into the storage unit 208 via the input/output interface 205. It is also possible to receive the program from a wired or wireless transfer medium using the communication unit 209 and install the program into the storage unit 208. As another alternative, the program can be installed in advance into the ROM 202 or the storage unit 208.

It should be noted that the program executed by a computer may be a program that is processed in time series according to the sequence described in this specification or a program that is processed in parallel or at necessary timing such as upon calling.

<Description of Depth Map in the Present Specification>

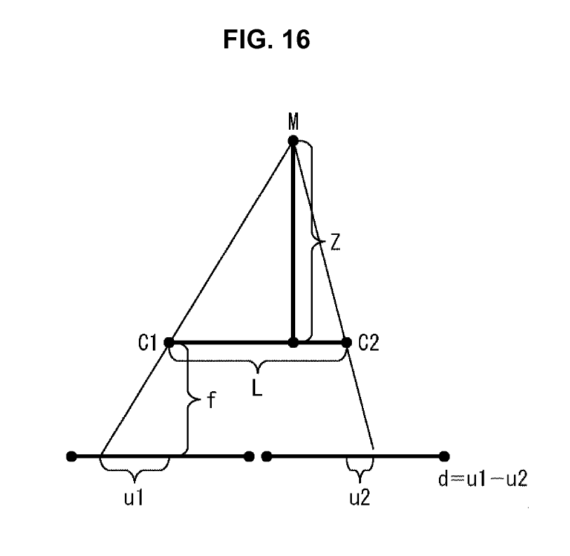

FIG. 16 is a diagram for describing disparity and depth.

As illustrated in FIG. 16, when a color image of a subject M is photographed by a camera c1 disposed at a position C1 and a camera c2 disposed at a position C2, a depth Z of the subject M, which is a distance of the subject from the camera c1 (camera c2) in a depth direction, is defined by Equation (a) below.

Z=(L/d)×f (a)

L is a distance (hereinafter referred to as an inter-camera distance) between the positions C1 and C2 in the horizontal direction. Also, d is a value obtained by subtracting a distance u2 of the position of the subject M on a color image photographed by the camera c2 in the horizontal direction from the center of the color image from a distance u1 of the position of the subject M on a color image photographed by the camera c1 in the horizontal direction from the center of the color image, that is, disparity. Further, f is a focal distance of the camera c1, and the focal distance of the camera c1 is assumed to be the same as the focal distance of the camera c2 in Equation (a).

As expressed in Equation (a), the disparity d and the depth Z can be converted uniquely. Accordingly, the above-described depth map can substitute an image indicating the disparity d between the 2-viewpoint color images photographed by the cameras c1 and c2. Hereinafter, the image indicating the disparity d and the depth map are generally referred to as a depth image.

The depth image may be an image indicating the disparity d or the depth Z, and not the disparity d or the depth Z itself but a value obtained by normalizing the disparity d, a value obtained by normalizing a reciprocal 1/Z of the depth Z, or the like can be used as a pixel value of the depth image.

A value I obtained by normalizing the disparity d by 8 bits (0 to 255) can be obtained by Equation (b) below. The number of bits for the normalization of the disparity d is not limited to 8 bits, but other numbers of bits such as 10 bits or 12 bits can be used.

$$I = \frac{255 \times ( d - {D}_{m i n} )}{{D}_{m ax} - {D}_{m i n}} \qquad ( b )$$

In Equation (b), Dₘₐₓ is the maximum value of the disparity d and Dₘᵢₙ is the minimum value of the disparity d. The maximum value Dₘₐₓ and the minimum value Dₘᵢₙ may be set in a unit of one screen or may be set in units of a plurality of screens.

A value y obtained by normalizing the reciprocal 1/Z of the depth Z by 8 bits (0 to 255) can be obtained by Equation (c) below. The number of bits for the normalization of the reciprocal 1/Z of the depth Z is not limited to 8 bits, but other numbers of bits such as 10 bits or 12 bits can be used.

$$y = 255 \times \frac{\frac{1}{Z} - \frac{1}{{Z}_{far}}}{\frac{1}{{Z}_{near}} - \frac{1}{{Z}_{far}}} \qquad ( c )$$

In Equation (c), Z_{far} is the maximum value of the depth Z and Zₙₑₐᵣ is the minimum value of the depth Z. The maximum value Z_{far} and the minimum value Zₙₑₐᵣ may be set in a unit of one screen or may be set in units of a plurality of screens.

As a color format of the depth image, YUV420, YUV400, or the like can be used. Of course, other color formats may be used.

Further, in the present disclosure, a system has the meaning of a set of a plurality of configured elements (such as an apparatus or a module (part)), and does not take into account whether or not all the configured elements are in the same casing. Therefore, the system may be either a plurality of apparatuses, stored in separate casings and connected through a network, or a plurality of modules within a single casing.

An embodiment of the disclosure is not limited to the embodiments described above, and various changes and modifications may be made without departing from the scope of the disclosure.

For example, in the first embodiment, the residual image generation unit 56 may generate the residual image by combining the difference of the non-occlusion region and the image of the neighboring viewpoint of the occlusion region. In this case, the residual image generation unit 56 generates a mask of the non-occlusion region or the occlusion region. Then, the separation unit 57 separates the residual image into the difference of the non-occlusion region and the image of the neighboring viewpoint of the occlusion region using the mask.

Even in the second embodiment, the residual image generation unit 56 may generate the residual image by combining the difference of the non-occlusion region and the image of the neighboring viewpoint of the occlusion region. In this case, the residual image generation unit 56 generates a mask of a region obtained by combining the region of the small difference or the region of the large difference and the occlusion region. Then, the separation unit 121 separates the residual image into the small difference, and the large difference and the image of the neighboring viewpoint of the occlusion region using the mask.

Further, in the second embodiment, the small difference and the large difference may be separated not by the determination of the threshold value but based on a predetermined evaluation function.

For example, the present disclosure can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Additionally, the present technology may also be configured as below:

(1) An encoding device including:

a non-occlusion region encoding unit configured to encode a difference between an image of a neighboring viewpoint, which is a viewpoint different from a criterion viewpoint, and a predicted image of the neighboring viewpoint of a non-occlusion region of the image of the neighboring viewpoint according to a first encoding scheme; and

an occlusion region encoding unit configured to encode an occlusion region of the image of the neighboring viewpoint according to a second encoding scheme different from the first encoding scheme.

(2) The encoding device according to (1), wherein the first encoding scheme is an encoding scheme of higher quality than the second encoding scheme.
(3) The encoding device according to (2), wherein the first encoding scheme is lossless encoding and the second encoding scheme is lossy encoding.
(4) The encoding device according to (2), wherein the first encoding scheme is lossy encoding of first quality and the second encoding scheme is lossy encoding of second quality lower than the first quality.
(5) The encoding device according to any one of (1) to (4),

wherein the non-occlusion region encoding unit encodes a difference smaller than a threshold value in the difference according to the first encoding scheme, and

wherein the occlusion region encoding unit encodes the occlusion region and a difference equal to or greater than the threshold value in the difference according to the second encoding scheme.

(6) The encoding device according to any one of (1) to (5), further including:

a criterion image encoding unit configured to encode an image of the criterion viewpoint; and

a depth map encoding unit configured to encode a depth map which is generated using the image of the criterion viewpoint and the image of the neighboring viewpoint and indicates a position of a subject in a depth direction.

(7) The encoding device according to any one of (1) to (6), wherein the first encoding scheme and the second encoding scheme are set according to use of the image of the neighboring viewpoint.
(8) The encoding device according to any one of (1) to (7), further including:

a transmission unit configured to transmit information indicating the first encoding scheme and the second encoding scheme.

(9) An encoding method including:

encoding, by an encoding device, a difference between an image of a neighboring viewpoint, which is a viewpoint different from a criterion viewpoint, and a predicted image of the neighboring viewpoint of a non-occlusion region of the image of the neighboring viewpoint according to a first encoding scheme; and

encoding, by the encoding device, an occlusion region of the image of the neighboring viewpoint according to a second encoding scheme different from the first encoding scheme.

(10) A decoding device including:

a non-occlusion region decoding unit configured to decode encoded data, which is obtained by encoding a difference between an image of a neighboring viewpoint, which is a viewpoint different from a criterion viewpoint, and a predicted image of the neighboring viewpoint of a non-occlusion region of the image of the neighboring viewpoint according to a first encoding scheme, according to a first decoding scheme corresponding to the first encoding scheme; and

an occlusion region decoding unit configured to decode encoded data, which is obtained by encoding an occlusion region of the image of the neighboring viewpoint according to a second encoding scheme different from the first encoding scheme, according to a second decoding scheme corresponding to the second encoding scheme.

(11) The decoding device according to (10), wherein the first decoding scheme is a decoding scheme of higher quality than the second decoding scheme.
(12) The decoding device according to (11), wherein the first decoding scheme is lossless decoding and the second decoding scheme is lossy decoding.
(13) The decoding device according to (11), wherein the first decoding scheme is lossy decoding of first quality and the second decoding scheme is lossy decoding of second quality lower than the first quality.
(14) The decoding device according to any one of (10) to (13),

wherein the non-occlusion region decoding unit decodes encoded data, which is obtained by encoding a difference smaller than a threshold value in the difference according to the first encoding scheme, according to the first decoding scheme, and

wherein the occlusion region decoding unit decodes encoded data, which is obtained by encoding the occlusion region and a difference equal to or greater than the threshold value in the difference according to the second encoding scheme, according to the second decoding scheme.

(15) The decoding device according to any one of (10) to (14), further including:

a criterion image decoding unit configured to decode encoded data of an image of the criterion viewpoint; and

a depth map decoding unit configured to decode encoded data of a depth map which is generated using the image of the criterion viewpoint and the image of the neighboring viewpoint and indicates a position of a subject in a depth direction.

(16) The decoding device according to any one of (10) to (15), wherein the first encoding scheme and the second encoding scheme are set according to use of the image of the neighboring viewpoint.
(17) The decoding device according to any one of (10) to (16), further including:

a reception unit configured to receive information indicating the first encoding scheme and the second encoding scheme,

wherein the non-occlusion region decoding unit performs the decoding according to the first decoding scheme corresponding to the first encoding scheme indicated by the information received by the reception unit, and

wherein the occlusion region decoding unit performs the decoding according to the second decoding scheme corresponding to the second encoding scheme indicated by the information received by the reception unit.

(18) A decoding method including:

decoding, by a decoding device, encoded data, which is obtained by encoding a difference between an image of a neighboring viewpoint, which is a viewpoint different from a criterion viewpoint, and a predicted image of the neighboring viewpoint of a non-occlusion region of the image of the neighboring viewpoint according to a first encoding scheme, according to a first decoding scheme corresponding to the first encoding scheme; and

decoding, by the decoding device, encoded data, which is obtained by encoding an occlusion region of the image of the neighboring viewpoint according to a second encoding scheme different from the first encoding scheme, according to a second decoding scheme corresponding to the second encoding scheme.

What is claimed is:

1. An encoding device comprising:
a non-occlusion region encoding unit configured to encode a difference between an image of a neighboring viewpoint, which is a viewpoint different from a criterion viewpoint, and a predicted image of the neighboring viewpoint of a non-occlusion region of the image of the neighboring viewpoint according to a first encoding scheme; and
an occlusion region encoding unit configured to encode an occlusion region of the image of the neighboring viewpoint according to a second encoding scheme different from the first encoding scheme.

2. The encoding device according to claim 1, wherein the first encoding scheme is an encoding scheme of higher quality than the second encoding scheme.

3. The encoding device according to claim 2, wherein the first encoding scheme is lossless encoding and the second encoding scheme is lossy encoding.

4. The encoding device according to claim 2, wherein the first encoding scheme is lossy encoding of first quality and the second encoding scheme is lossy encoding of second quality lower than the first quality.

5. The encoding device according to claim 1,
wherein the non-occlusion region encoding unit encodes a difference smaller than a threshold value in the difference according to the first encoding scheme, and
wherein the occlusion region encoding unit encodes the occlusion region and a difference equal to or greater than the threshold value in the difference according to the second encoding scheme.

6. The encoding device according to claim 1, further comprising:
a criterion image encoding unit configured to encode an image of the criterion viewpoint; and
a depth map encoding unit configured to encode a depth map which is generated using the image of the criterion viewpoint and the image of the neighboring viewpoint and indicates a position of a subject in a depth direction.

7. The encoding device according to claim 1, wherein the first encoding scheme and the second encoding scheme are set according to use of the image of the neighboring viewpoint.

8. The encoding device according to claim 1, further comprising:
a transmission unit configured to transmit information indicating the first encoding scheme and the second encoding scheme.

9. An encoding method comprising:
encoding, by an encoding device, a difference between an image of a neighboring viewpoint, which is a viewpoint different from a criterion viewpoint, and a predicted image of the neighboring viewpoint of a non-occlusion region of the image of the neighboring viewpoint according to a first encoding scheme; and
encoding, by the encoding device, an occlusion region of the image of the neighboring viewpoint according to a second encoding scheme different from the first encoding scheme.

10. A decoding device comprising:
a non-occlusion region decoding unit configured to decode encoded data, which is obtained by encoding a difference between an image of a neighboring viewpoint, which is a viewpoint different from a criterion viewpoint, and a predicted image of the neighboring viewpoint of a non-occlusion region of the image of the neighboring viewpoint according to a first encoding scheme, according to a first decoding scheme corresponding to the first encoding scheme; and
an occlusion region decoding unit configured to decode encoded data, which is obtained by encoding an occlusion region of the image of the neighboring viewpoint according to a second encoding scheme different from the first encoding scheme, according to a second decoding scheme corresponding to the second encoding scheme.

11. The decoding device according to claim 10, wherein the first decoding scheme is a decoding scheme of higher quality than the second decoding scheme.

12. The decoding device according to claim 11, wherein the first decoding scheme is lossless decoding and the second decoding scheme is lossy decoding.

13. The decoding device according to claim 11, wherein the first decoding scheme is lossy decoding of first quality and the second decoding scheme is lossy decoding of second quality lower than the first quality.

14. The decoding device according to claim 10,
wherein the non-occlusion region decoding unit decodes encoded data, which is obtained by encoding a difference smaller than a threshold value in the difference according to the first encoding scheme, according to the first decoding scheme, and
wherein the occlusion region decoding unit decodes encoded data, which is obtained by encoding the occlusion region and a difference equal to or greater than the threshold value in the difference according to the second encoding scheme, according to the second decoding scheme.

15. The decoding device according to claim 10, further comprising:
a criterion image decoding unit configured to decode encoded data of an image of the criterion viewpoint; and
a depth map decoding unit configured to decode encoded data of a depth map which is generated using the image of the criterion viewpoint and the image of the neighboring viewpoint and indicates a position of a subject in a depth direction.

16. The decoding device according to claim 10, wherein the first encoding scheme and the second encoding scheme are set according to use of the image of the neighboring viewpoint.

17. The decoding device according to claim 10, further comprising:
a reception unit configured to receive information indicating the first encoding scheme and the second encoding scheme,
wherein the non-occlusion region decoding unit performs the decoding according to the first decoding scheme corresponding to the first encoding scheme indicated by the information received by the reception unit, and
wherein the occlusion region decoding unit performs the decoding according to the second decoding scheme corresponding to the second encoding scheme indicated by the information received by the reception unit.

18. A decoding method comprising:
decoding, by a decoding device, encoded data, which is obtained by encoding a difference between an image of a neighboring viewpoint, which is a viewpoint different from a criterion viewpoint, and a predicted image of the neighboring viewpoint of a non-occlusion region of the image of the neighboring viewpoint according to a first encoding scheme, according to a first decoding scheme corresponding to the first encoding scheme; and
decoding, by the decoding device, encoded data, which is obtained by encoding an occlusion region of the image of the neighboring viewpoint according to a second encoding scheme different from the first encoding scheme, according to a second decoding scheme corresponding to the second encoding scheme.
